(19) United States
(12) Patent Application Publication
(10) Pub. No.: US 2010/0170448 A1
(43) Pub. Date: Jul. 8, 2010

(54) e-PAWS electronic pet automated watering system

(76) Inventors: Chris Brian Warwick, Buford, GA (US); Kimbery Sue Warwick, Buford, GA (US)

Correspondence Address: Chris B. Warwick, 4471 Keenly Valley Dr., Buford, GA, 30519, US

(21) Appl. No.: 12/583,234

(22) Filed: Sep. 28, 2009

Related U.S. Application Data
(60) Provisional application No. 61/204,347, filed on Jan. 5, 2009.

(51) Int. Cl. A01K 29/00; A01K 7/00

(52) U.S. Cl. 119/72

(57) ABSTRACT

Improvements in pet care or animal hydration are disclosed. According to the broadest aspect the invention is an electronic pet automated watering system, to be known as EPAWS, used in the pet or animal care, which includes a housing that contains the electronics, a water solenoid valve and vessel for filling with water. The electronically controlled water solenoid valve that is operated by a capacitive proximity sensor to fill and monitor the water level in the vessel, the housing that connects to the either, a residential or commercial water supply with a power source of 110 volts A/C (Alternating Current). Connect the housing to the vessel, a safety switch is provided to ensure the housing and vessel are connected. Once the water supply is connected and the water supply valve is opened, the housing is plugged into an A/C outlet, a switch is provided in the housing to turn the EPAWS system on or off. When the system is turn on the capacitive proximity sensor will not sense the presence of the water there by closing a relay which turns on the solenoid water valve, once the water in the vessel has reached the capacitive proximity sensor it will close the solenoid water valve, until the level water is consumed by the pets or animals, to which the process starts again.

The e-PAWS system a uniquely designed automated pet watering system using sophisticated electronics to automatically maintain a constant water level in a vessel designated for pet(s) hydrating needs by plumbing it directly into your home or facilities water supply, maintaining the hydration needs while owners or care takers are away.

The e-PAWS design and utility is a Control housing, made from polymers (plastic) that when plugged into a 110v outlet, and the switch turn on the power has two functions (1) to operate the 12 vdc power 200 ma supply which supports the capacitive proximity sensor, 12 vdc relay, and voltage regulator which is interrupted by a snap switch in series with the 12 vdc relay positive. (2) 94 vac to 128 vac operates the water fill solenoid which is a normally closed valve; all contained in the control housing which sits on top of the water vessel; made from polymers (plastic).

Connecting and Using EPAWS.

Connect the EPAWS to an existing water line with a tee to the quarter inch water line tighten to ensure no leaks, place the control housing onto the water vessel. Plug the power cord into a wall outlet (120v). Turn the EPAWS on via the switch on the left side of the control housing. The EPAWS will now start filling the water vessel and will stop automatic, when it reaches the capacitive proximity sensor. As the pet(s) drink from the EPAWS it will refill continuously until the water reaches the sensor 24 hours a day 7 days a week.
The water vessel should be cleaned at least once a week.

### EPAWS INVENTION HAS TWO MAIN PARTS

1. Control housing; containing the following parts; on/off switch, power supply, voltage regulator, capacitive proximity sensor, water fill valve, control relay, power cord, and snap switch.

2. Water vessel.

Whether the system is used for residential use or commercial use of the system is easily installed using a water line such as a refrigerator or sink water line and a, 110v power outlet.

### BRIEF DESCRIPTION OF DRAWINGS

FIG. 1 is the right side view of the control housing, which contains the electronics of the present invention.

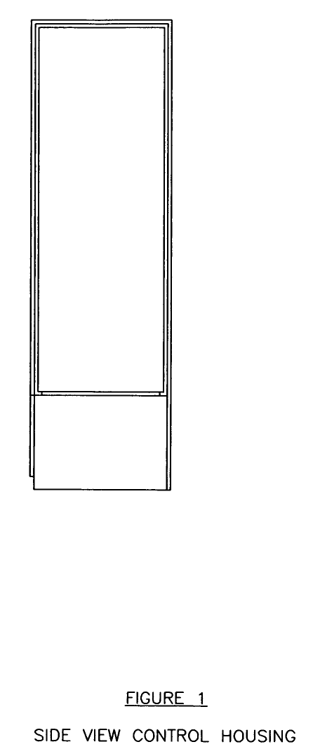

FIG. 2 is the front view of the control again contains the electronics.

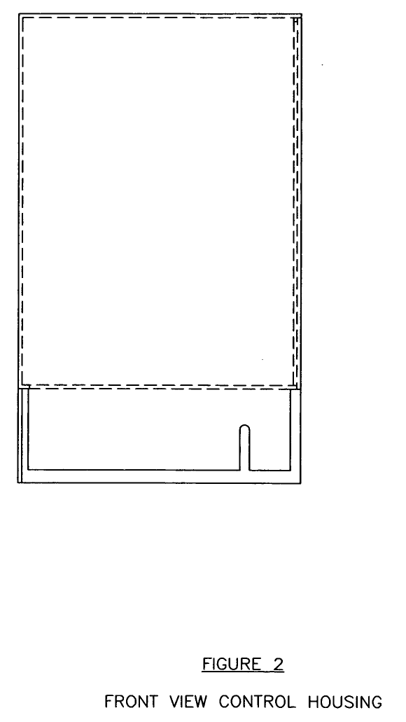

FIG. 3 is the front view of the electronics and valve mounting panel, of the present invention.

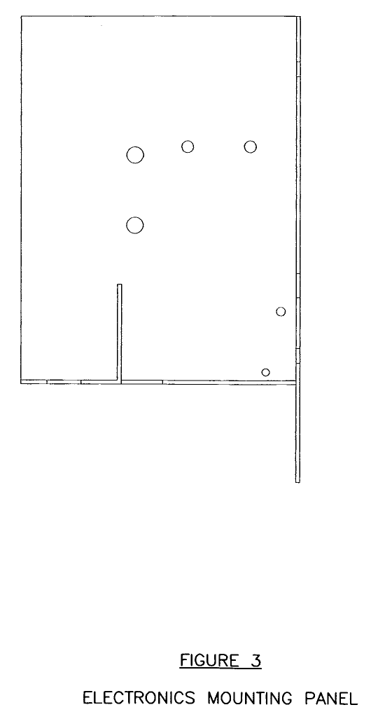

FIG. 4 is the right side view of the electronics and valve mounting panel.

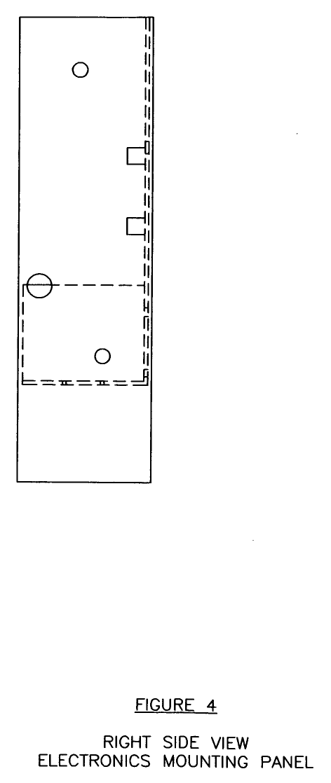

FIG. 5 is the top view of the water vessel of the present invention.

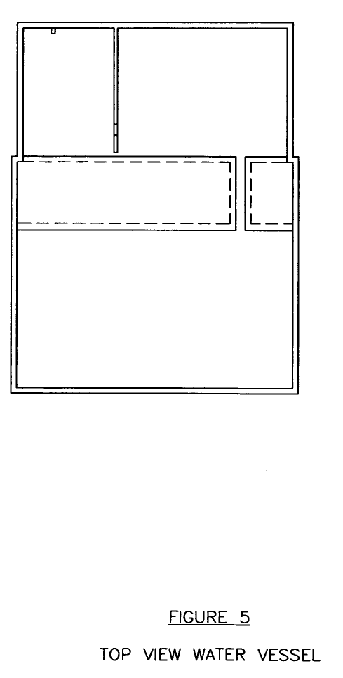

FIG. 6 is the left side view of the of the water vessel.

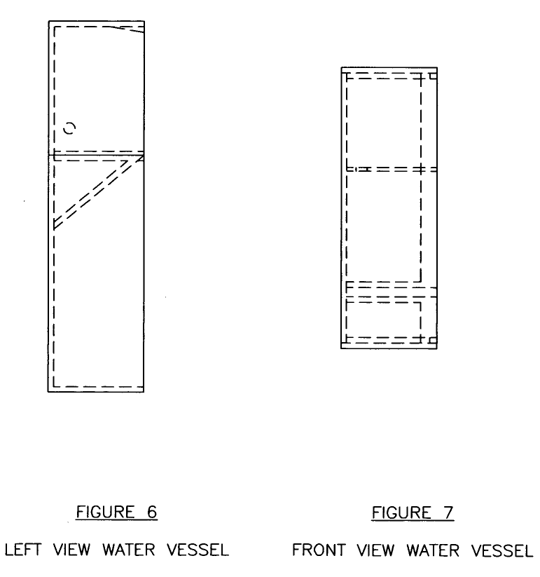

FIG. 7 is the front view of the water vessel.

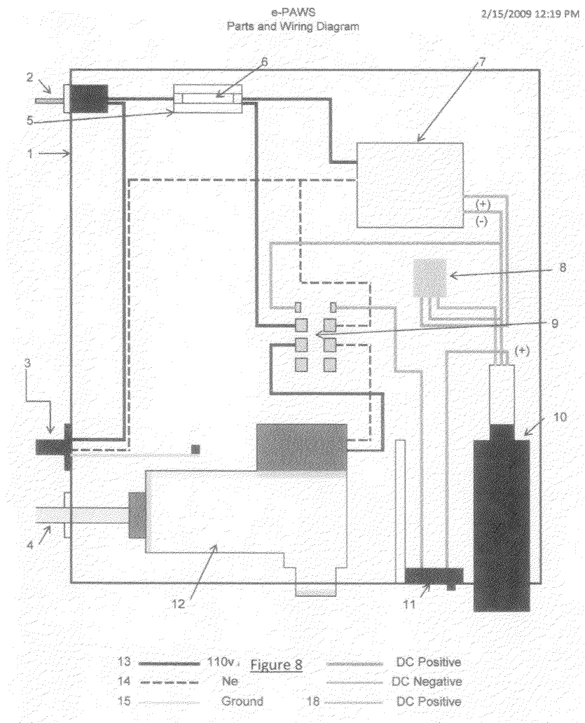

FIG. 8 is the electronics and parts diagram of the present invention.
1. Electronics Mounting panel
2. On/Off switch
3. Power cord
4. Water line
5. Fuse holder
6. Fuse
7. D/C power supply
8. Voltage regulator
9. Relay
10. Capacitive proximity sensor
11. Snap switch
12. Solenoid water valve

I claim:

1. EPAWS invention is an electronic automated self filling pet or animal watering system, for use in residential and commercial use comprising of:
a housing made from polymers (plastic) including a means of connecting to a electrical and water supply; i.e. power cord and tubing for water line;
a capacitive proximity sensor to control the level of water;
a solenoid water valve to allow water to flow into the vessel;
a on/off switch for turning system on or off;
a fuse to protect the circuit(s);
a fuse holder to hold the fuse;
a direct current power supply to power capacitive proximity sensor and relay;
a direct current voltage regulator to control voltage to the capacitive proximity sensor and the direct current relay;
a snap switch to interrupt the power if control housing and vessel become separated;
a direct current relay to operate (open and close) the solenoid water valve;
a water vessel made from polymers (plastic) with anti slosh to keep water from sloshing on the capacitive proximity sensor.
